(19) United States
(12) Patent Application Publication
(10) Pub. No.: US 2022/0374610 A1
(43) Pub. Date: Nov. 24, 2022

(54) Methods and system for analyzing human communication tension during electronic communications.

(71) Applicant: Abhishek Vikram, Santa Clara, CA (US)

(72) Inventor: Abhishek Vikram, Santa Clara, CA (US)

(21) Appl. No.: 17/326,983

(22) Filed: May 21, 2021

(51) Int. Cl. G06F 40/40; G06F 40/237; G10L 25/63

(52) U.S. Cl. CPC G06F 40/40; G06F 40/237; G10L 25/63

(57) ABSTRACT

A method and system for analyzing and detecting a human tension based conflict between one or more parties using electronic communication data generated during communication between those parties. The method includes receiving electronic communication data, analyzing the electronic communication data by applying a predetermined method and generating conflict analysis score, the conflict analysis score providing a trigger or a seed for the conflict form the analyzed electronic communication data. In one or more embodiments, electronic communication data may be one or more of electronic-mail data, web content data, text message data, voice data, video content data, social media data.

### TECHNICAL FIELD OF THE DISCLOSURE

The present disclosure relates generally to a method and system for analyzing electronic communication data to detect and analyze a human tension based conflict between one or more parties communication, and more particularly applying a conflict analysis method to electronic communication data in between one or more parties to generate unbiased conflict assessment score and to identify a conflicting trigger.

### BACKGROUND OF THE DISCLOSURE

The popularity and widespread use of electronic communication, including a text, audio and video communications has risen in recent years. The electronic communications channels including social networking websites, such as FaceBook®, Twitter®, Snapchat® and Linkedin® etc. have become a popular method of communication in today's era. Electronic communications are used not only for social networking conversations, but also for several formal settings communication for businesses, schools as well as administrative conversations.

A typical electronic communication includes various informal and formal words and expressions such as “That's a really good question” or “I cannot understand your question” etc. Unfortunately, for some people, communicating efficiently in this setting may be challenging. This challenge may cause a series of misunderstandings leading a human tension based conflict in between one or more parties. To maintain the integrity of formal settings including business communication it is important to identify the main cause of conflict or the conflicting trigger by analyzing the digital and electronic records of communication.

Businesses and organizations implement strategic consultation and group activities to solve the conflicts that arise through electronic communication but the analysis of the digital communication to identify the conflicting trigger or a root cause of the conflicting event is important to supplement the strategic consultation for a better outcome. Normally they engage external experts to diagnose the conflict intervening with the parties involved who then finally prescribes steps for resolution. Engaging an external expert is expensive sometimes. Many smaller organizations are not able to afford this service and live with the conflict, thereby increasing stress of their employees and reducing operational efficiency over time. Also, the confidentiality of the organization is compromised by allowing an external private agency to probe with the employees during consultation.

Accordingly, there is a need for a method or system to identify the conflicting trigger and event of conflict in between one or more parties by analyzing the communication record that may be available in digital and electronic formats. in particular, a need exists for a method and system with a conflict analysis model which detects and analyses electronic communications data to provide information about the severity of the root cause or conflicting trigger of conflicting communication as well as identifying the parties responsible for he conflict without any bias towards or against any party.

### SUMMARY OF THE DISCLOSURE

An aspect of the specification provides a method for analyzing and detecting human tension-based conflicts between two or more parties' electronic communication data by utilizing various data contents in order to identify a trigger of a conflict event during communication. The method also provides a time duration in which conflict was started between two or more parties by capturing the evolution of conflict on a time scale. The first instance of conflict causing communication is depicted as seed on the time scale.

According to one embodiment, a method and system is provided for analyzing electronic communication data of one or more types to detect and identify conflicts between the communication of one or more parties. Once electronic communication data is received by a system or a computer product program, data associated with the electronic communication between parties are determined and then analyzed by applying a predetermined human tension based conflict analysis method. In case there is no prior electronic data available related to the conflict then such data is generated by engaging with the conflicting parties. Based on their availability they are asked to provide their own perspective of the conflict in any storage format like text, audio or video files.

According to another embodiment, a method for analyzing electronic communication data to identify a human tension based conflict and detect a conflicting trigger may include aggregate electronic communication data. In some embodiments, aggregated electronic communication data may be used to generate a text file. The aggregated electronic communication data may be analyzed by mining the text file and applying a predetermined human tension based conflict analysis method to the text file. A generated conflict assessment results or score include a name of party or parties involved in a communication, a trigger or a seed in the communication, a time when the conflict started and an unbiased conflict score of communication.

According to another embodiment, a method of analyzing electronic communication data generated through social media communication to identify a human tension based conflict is provided. Once a social media data file is received by a computer program product, the social media data can be analyzed by mining the social media data and applying a predetermined human tension based conflict analysis method. A generated conflict assessment results or score include a name of party or parties involved in a communication, a trigger or a seed in the communication, a time when the conflict started and an unbiased conflict score of communication.

According to another embodiment, a method of analyzing electronic communication data generated through audio and video communication to identify human tension based conflict is provided. Once an audio and/or video data file is received by a computer program product, the audio and video can be analyzed to observe various voice impressions as well as facial expressions, body posture, gestures and eye movement. Conflict assessment data is generated based on the step of analyzing the electronic communication data. A generated conflict assessment results or score include a name of party or parties involved in a communication, a trigger or a seed in the communication, a time When the conflict started and an unbiased conflict score of communication.

According to another embodiment, a method of analyzing electronic communication to identify human tension based conflict between two or more parties includes at least two steps for a human tension based conflict score generation.

The methods described can be embodied in a non-transitory computer readable medium adapted to control an executable computer readable program code for implementing one or more of the methods therein. The computer program would include code segments or routines to enable all of the functional aspects of the interface described or shown herein.

According to yet another embodiment, the computer program also includes a code segment for generating a graphical user interface (“GUI”). The GUI can also be embodied in a computer program stored on computer readable media. The computer program would include code segments or routines to enable all of the functional aspects of the interface described or shown herein.

Other features and advantages will be apparent from the following specification taken in conjunction with the following drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a simplified block diagram of a computing device according to one or more embodiments.

FIG. 2 is a simplified diagram illustrating a different type of electronic communication data in accordance with some embodiments.

FIG. 3 is a schematic illustration of a method for analysis and detection of a human tension based conflict in accordance with some embodiments.

FIG. 4 is a flow chart illustrating a method for analysis and detection of a human tension based conflict in accordance with some embodiments.

FIG. 5 is a flow chart illustrating a conflict analysis score generation for analysis and detection of a human tension based conflict in accordance with some embodiments,

FIG. 6 is a flow chart illustrating a method for conflict analysis, conflict analysis score generation for analysis and detection of a human tension based conflict in accordance with some embodiments.

FIG. 7 is a display of a score illustrating an output of the method for analysis and detection of a human tension based conflict in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE DISCLOSURE

An aspect of the specification provides a method for detecting and analyzing electronic human tension based conflict and generating conflict assessment score where the method includes a receiving electronic communication data, determining customer identification data associated with the electronic customer communication data by the contact center; aggregating electronic communication data based on identification of a party from the electronic communication data; analyzing the aggregated electronic communication data by applying a predetermined conflict assessment analysis to the electronic communication data; generating a conflict assessment score based on said analysis, the conflict assessment score providing a party responsible for the conflict for the analyzed electronic communication data; and displaying the conflict assessment score based on the generated conflict assessment data.

An another aspect of the specification provides a computer program product stored on a non-transitory computer readable medium including computer executable code for analyzing electronic communication data and generating conflict assessment score, the computer program product includes a computer readable code to receive electronic customer communication data by a contact center, computer readable code to determine customer identification data associated. with the electronic customer communication data by the contact center, computer readable code to aggregate electronic customer communication data by customer category from one or more sources based on identification of customer from the electronic customer communication data, computer readable code to analyze the aggregated electronic communication data by applying a predetermined conflict assessment analysis to the electronic customer communication data, computer readable code to generate conflict assessment data based on said analyzing, the conflict assessment score providing a party responsible for a human tension based conflict for the analyzed electronic communication data and computer readable code to display the conflict assessment score based on the generated conflict assessment data.

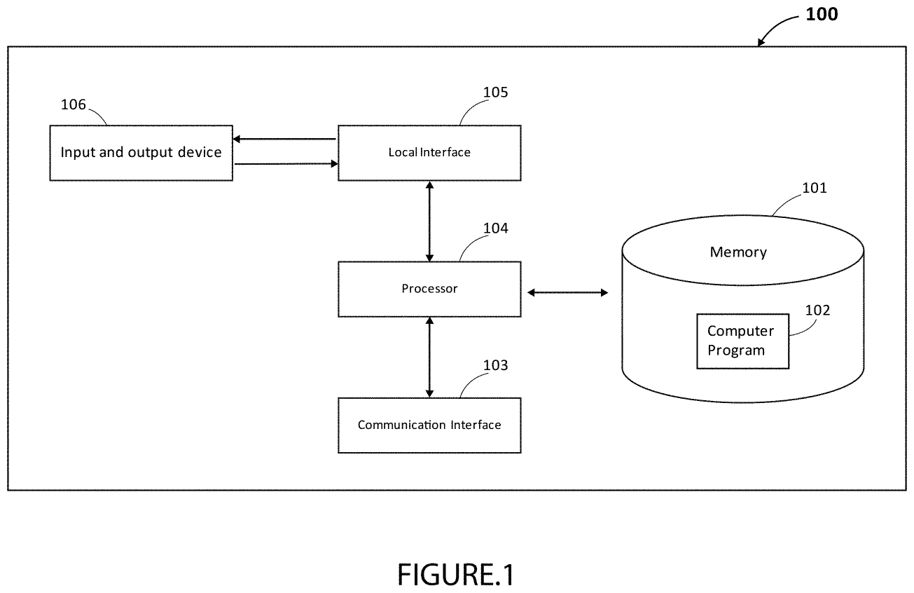

FIG. 1 is a simplified block diagram of a computing device according to one or more embodiments. Computing device 100 may be configured to install a system or a computer program product to receive electronic communication data files of one or more parties and further designed to analyze and detect a human tension based conflict according to one or more embodiments.

For purposes of understanding the hardware as described herein, the terms “computer” and “server” have identical meanings and are interchangeably used. Computing device 100 includes processor 104, and memory 101 storing a computer program product 102. As shown in FIG. 1, computing device 100 additionally includes local interface 106 and communication interface 103. Processor 104 can be a hardware device for executing software, including computer program 102 stored in memory 101. Processor 104 can be a custom made or commercially available processor, a central processing unit (CPU), an auxiliary processor among several processors associated with the computing device 200, a semiconductor-based microprocessor (in the form of a microchip or chip set), a microprocessor, or generally any device for executing software instructions.

According to one or more embodiments, memory 101 can include anyone, or combination of, volatile memory elements (e.g., random access memory (RAM, such as DRAM, SRAM, SDRAM, etc.)) and nonvolatile memory elements (e.g., ROM, hard drive, tape, CDROM, etc.). Moreover, memory 101 may incorporate electronic, magnetic, optical, and/or other types of storage media. In some embodiments, memory 101 may have a distributed architecture where various components are situated separate from, or remote from, one another, but can be accessed by the processor 104. Memory 101 can include one or more separate programs, each of which having an ordered listing of executable instructions for implementing logical functions. For example, memory 101 can include computer program 102 and one or more programs for providing an operating system (O/S). Computer program product 102 can be implemented in software (e.g., firmware), hardware, or a combination thereof. Computer program 102 may be a control system, a source program, executable program (object code), script, or any other non-transitory computer readable code comprising instructions to be performed. When computing device 100 is in operation, the processor 104 is configured to execute software stored within the memory 101, to communicate data to and from the memory 101, and to generally control operations of the computing device 100 pursuant to the software.

In one embodiment, computer program 102 may be implemented in software and may be stored on any non-transitory computer readable medium for use by or in connection with any computer related system or method. In the context of this document, a “computer-readable medium” can be any non-transitory means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). In another embodiment, computer program 102 may be implemented in hardware by one or more of a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

I/O devices 106 may include input devices, for example but not limited to, a keyboard, mouse, scanner, microphone, touch screens, interfaces for various medical devices, bar code readers, stylus, laser readers, radio-frequency device readers, etc. Furthermore, the I/O devices 106 may also include output devices, for example but not limited to, a printer, barcode printers, displays, etc. I/O devices 106 may further include devices that communicate both inputs and outputs, for instance but not limited to, a modulator/demodulator (modem; for accessing another device, system, or network), a radio frequency (RF) or other transceiver, a telephonic interface, a bridge, a router, etc. in certain embodiments processor 104 of computing device 100 may include communication interface 103 for communication with one or more or other devices via wired and/or wireless communication. Communication interface 103 may be configured to allow for communication via a communication network. Thus, electronic communication data can be received directly from one or more other wired devices via wired and/or wireless communication.

According to another embodiment, a method of analyzing electronic communication data and further detecting a conflict includes aggregating electronic communication data or may be input in the computing device 100 using one or more computer program 102.

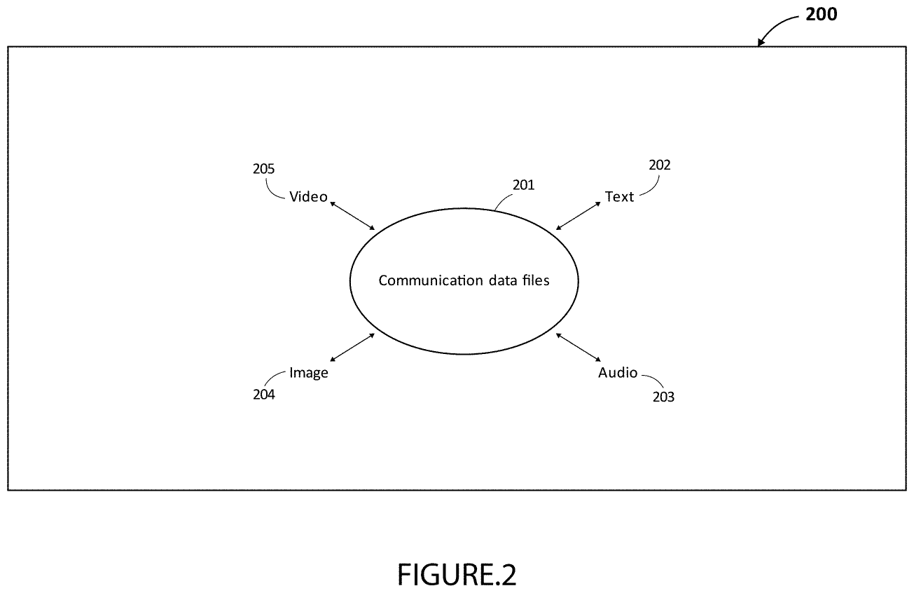

FIG. 2 illustrates a different type of electronic communication data 200 that may be generated during communication between two or more parties. Electronic interaction between two or more parties where a data or content is passed, transferred, or exchanged. This communication may be referred to as electronic or digital communications through various channels including a telephone conversation, audio, video, voice over data, screen events, chat messages, text, survey results, quality management forms results, email messages, social media websites, social media messengers or any other data. According to some embodiments two or more communicating parties may be but not limited to two or more office colleagues, marketing or customer service representatives and their customers, two or more family members and two or more friends.

As illustrated in FIG. 2, the different types of electronic communication data 200 may be generated during communication between two or more parties during the electronic communication. The electronic communication data 200 may he generated from smart computing devices, mobile devices, telecommunication devices and the like. Smart computing devices can be computing devices such as laptop or desktop computers, smartphones, PDAs, portable media players, tablet computers, televisions or other displays with one or more processors coupled thereto or embedded therein, or other appropriate computing devices that can be used for displaying a web page or web application.

According to one embodiment, a data file 201 may be a text file 202, audio file 203, video file 205 and image file 204. The text file 202 may include .doc and .docx—Microsoft Word file, .odt—OpenOffice Writer document file, .pdf—PDF file, .rtf—Rich Text Format, .txt—Plain text file, .wpd—WordPerfect document and the like. The text file data 201 may include data can be one or more of electronic mail data, electronic social media data, and web content data electronic mail data, electronic social media data, and web content data (including internet survey data, blog data, micro-blog data, online video transcript data, discussion forum data, chat feed data), SMS data. VoIP data, and other electronic communication content data.

According to one embodiment, a data file 203, may be an audio file. The audio file 203 may include MPEG Audio Layer-3 (MP3), MPEG Audio Layer-4 (MP4) and the like. According to another embodiment, a data file 204, may be an image file. The image file 204 may include JPG, TIF, PNU, GIF and the like. According to another embodiment, a data file 205 may be a video file. The video file may include MP4 and the like.

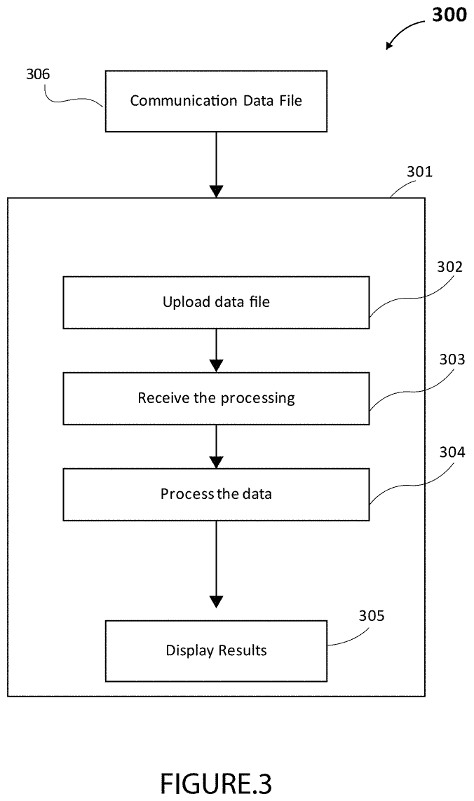

FIG. 3 is a schematic illustration of a method for analysis and detection of a human tension based conflict in accordance with some embodiments. Referring now to FIG. 3 the method for a human tension based conflict detection 301 can be performed by a computer program product 102 on a computing device 100 as illustrated in FIG. 1. Referring to FIG. 3, the method for a human tension based conflict detection 301 includes an operation 302 where an electronic communication data is received, at operation 303 a data processing can he executed. At operation 304, the data can be processed. The method for human tension based conflict detection 301 further provides a human tension based conflict detection and analysis results or score at operation 305 by displaying it on an interface of the computer program product 102. The method for human tension based conflict detection 301 is designed to analyze the communication data file 302 generated during the electronic interactions as illustrated in FIG. 2. The communication data file 302 can be a telephone conversation, audio, video, voice over IP, data packets, screen events, entails, chat messages, text, and survey results, quality management forms results, collaborative browsing results, email messages or any other coded data. At operation 305 the data processing performed by the processor for human tension based conflict detection 301 are stored and could be accessed in order to structure and display specific queries and reports.

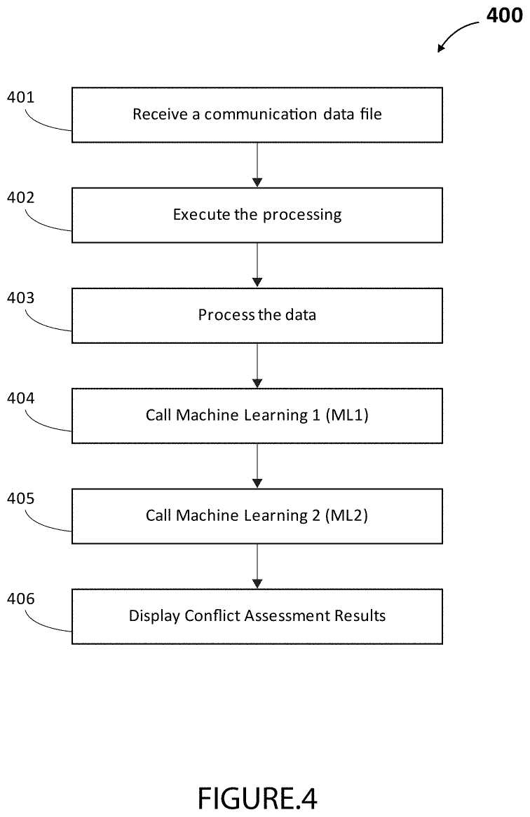

FIG. 4 is a flowchart illustrating a method 400 for analysis and detection of a human tension based conflict can be performed by a computer program product 102 on a computing device 100 as illustrated in FIG. 1. As illustrated in FIG. 4, at the operation 401 a communication data file can be received by a computer program product 102. The communication data file can be any type of social media, such as, but not limited to audio, video, screen images, email content, chat content, and the like. The social media files can be selected in the form of but not limited to audio, video, screen images, text communications. At the operation 401, two or more files can be received at the same time from two or more parties of interest. The computer program product 102 is also designed to receive two different file types or formats at the same time to process the data content. At the operation 402, a user can select a type or format of file that is received in the operation 401 to further start the processing of the data files according to the operation 403.

At operation 403, the data files are parsed to identity the communication string between two parties and further extract the tags to identify several indicators such as but not limited to “From”, “To” and the time of each communication. The operation 403 is further designed to perform a text analytics to extract keywords and an audio analytic to extract an intonation with keywords. The intonation can be any variation in spoken pitch but not limited to when used as a sememes (a concept known as a tone), attitudes and emotions of the speaker, signaling the difference between statements and questions, and between different types of questions and focusing attention on important elements of the spoken message. At operation 403 the processing is designed to identify all action and description words (verbs, adjectives) that can be used in communication between two or more parties. The analysis further designed to analyse and establish the association of words with data is stored in a repository. The processing generates a score after the text and audio analysis. The analysis function includes but not limited to analysis of the text and audio data files.

The operation 404 is designed to calculate the conflict score of each individual set of a communication data between two parties. The operation 404 is also referred to as a Machine Learning 1 (ML1) analysis. The operation 404 calculates the conflict score by analyzing one time communication by each party, starting from a very first seed or trigger event. The severity of the words and phrases are interpreted within each set of conversation and assigned a score that is based on a linguistics psychology where audio and video files also provide the intonation information. The ML1 analysis is designed to detect the parts of speech like verbs and adverbs front the communication data files to analyze the conflict in between the communication. The verbs may include but not limited to suspend, fire, leave, go, “not <verb>” like not invited, not doing, etc. The adverb may include but not limited to deadly, badly, highly, rightly, surely and lately. The trigger or seed event refers to the first instance of the human tension based conflict that can be at subconscious level and normally overlooked during electronic communication. The seed or trigger event may not be referred to as an actual conflict. The method 400 is designed to process all communication data files to analyze the real cause of conflict, The ML1 analysis is designed to consider all the prior communications leading up to the visible conflict, for example, this way the analysis system can link up the cause of a present conflict to the crunch of resources from the start of the communication. The ML1 analysis is designed to analyze the conflict in an unbiased manner without framing any party as the cause rather identifying the reason that created the conflict.

The operation 405 is referred to as a Machine Learning 2 (ML2) analysis to calculate the conflict score of each set of communication data between two parties. The ML2 analysis is designed to perform after the individual sets of conversations have been processed and the ML1 analysis score is available for the complete communication. This operation may include multiple sets of communications in the dataset if the parties have communicated multiple times with each other using the same or different communication channels. This operation is also designed to process the multiple sets and also include more than one form of communication formats, like email, audio and video files.

The scores from ML1 are accumulated for the complete dataset across all time nodes and a final severity analysis is done. The identified words and phrases are ranked on a global scale (percentile score). The relative score of each time node for the respective speakers are calculated and stored. It is later displayed in the preceding and proceeding texts to determine the intent. At operation 405, excited result screen to relay the relative conflict contribution of each instance is processed by the analyzer and relayed for display. At the operation 406, the human tension based conflicts assessment results get displayed on a display screen. The user has the ability to retrieve ML1 and ML2 scores separately or in combination for particular communication. The user also has the ability to retrieve the score or assessment results for particular words/phrases to get an unbiased understanding of the evolution of the conflict.

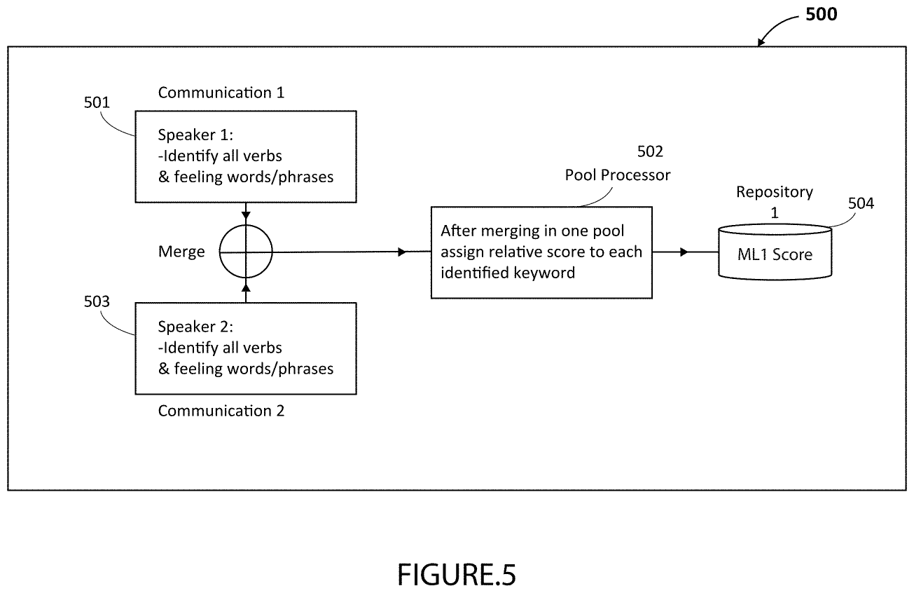

FIG. 5 is a flow chart illustrating a conflict analysis score generation for analysis and detection of a human tension based conflict in accordance with some embodiments. The analysis is also referred to as a Machine Learning 1 (ML1) analysis. The ML1 analysis is a first level of scoring the conflict causing words or phrases by processing each set of communication in between each party separately, At operation 501 and 503, a one set of communication including a communication string by a first party or a speaker 1 and a response from a second party or speaker 2 is identified. Each set of communication starts chronologically from a first available conversation between the parties. The analysis of each set of communication designed to perform an independent analysis of each set of conversation without being influenced by any other prior communication. At operation 501 and 503, the communication by each party or speaker is merged into a pool processor to assess a relative score.

At operation 502, the pool processor is designed to pool the words from each party at any given instant and brings the conversation to the context to determine the conflict. A ML1 score is assigned to the conflict causing words/phrases which are identified in the operation 504. The ML1 score is further designed to be stored into a repository. The ML1 score can also be referred to as a local score as it is designed to capture a level conflict at any instance.

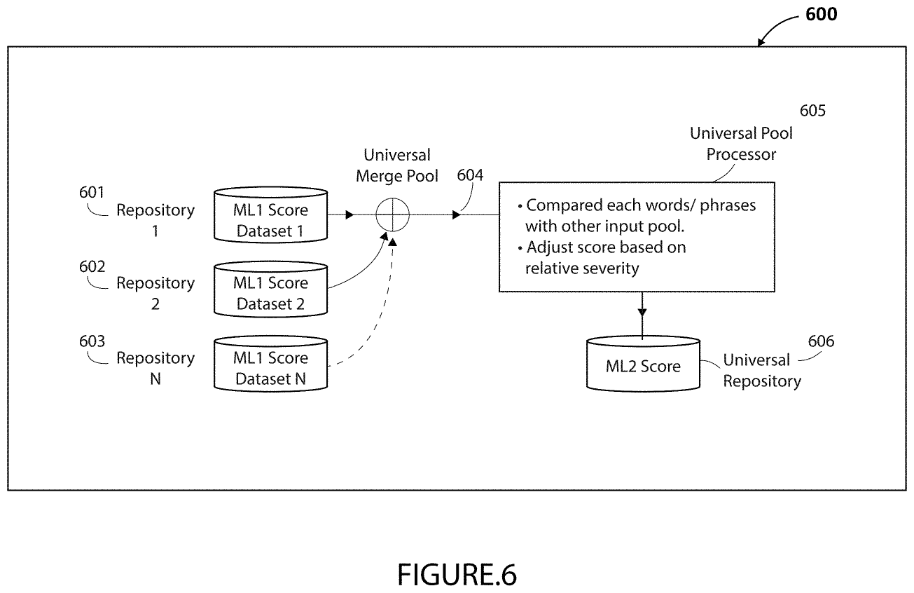

FIG. 6 is a flow chart illustrating a conflict analysis score generation for analysis and detection of a human tension based conflict in accordance with some embodiments. The analysis is also referred to as a Machine Learning 2 (ML2) analysis. The ML2 score analysis is designed to be performed after the individual sets of conversations or data have been processed into the individual repositories and the ML1 score is already assigned as illustrated in the individual repositories 601, 602 and 603 which are designed to be further processed under the ML2 analysis. Each repository 601, 602 and 603 has a dataset with predetermined ML1 score.

The ML2 score analysis is not limited to the number of repositories and designed to process the multiple repositories at the same time. At the operation 604, all three repositories 601, 602 and 603 with respective datasets are designed to merge in a universal pool processor. The universal pool processor is designed to analyse the local or ML1 score of each repository and further designed to adjust score by comparing scores in each individual repository to another.

The adjusted score is referred to as a ML2 analysis score and designed to store in a universal repository at the operation 606. The ML2 analysis score can also be referred to as a global score. Both the values of the ML1 and ML2 scores can be varied and used independently when required. For example, in case of shorter length of communication between the parties, it may assign a low ML1 score depending on the severity of the word within the communication data. For the same keyword the ML2 score can be high based on its universal severity.

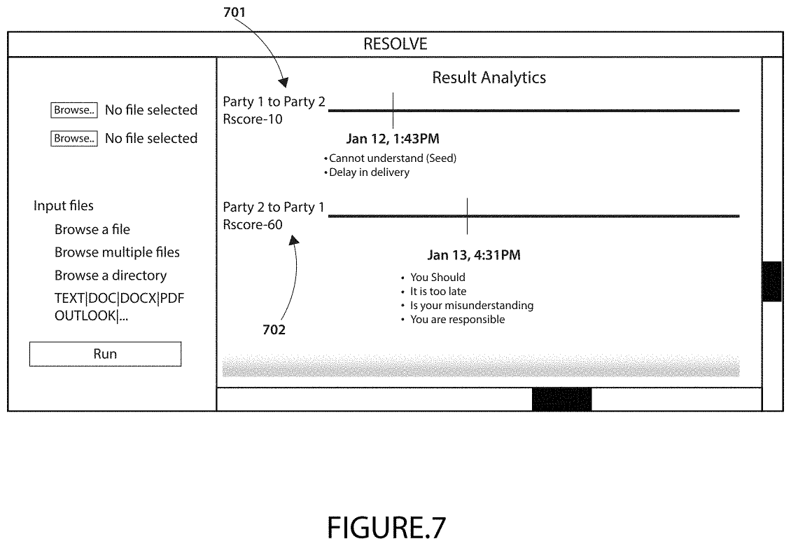

FIG. 7 is a display of a score illustrating an output of the method for analysis and detection of a human tension based conflict in accordance with some embodiments. As illustrated, a score 701 and a score 702 is calculated based on a weighting function that is derived from the ML2 analysis score values in the universal repository. For example, the higher score 702 indicates the party 2 may have used more conflict causing words. In other words that party can be considered as a responsible party for the conflict.

The timeline for each speaker shows the snippets from each instance of conversation. The top N (configurable) conflict words are listed from each instance on the timeline with the timestamp when it was said by the speaker. This chronological layout of the conflict words provides an easy understanding of the conflict evolution over time. Users also have a choice to click on any instance on the timeline and open the complete conversation for that selected instance to get the comprehension.

As used herein, a term referring to “repository” is a computer program designed to store the results of the process connected to the repository. The repository is structured such that it stores all the relevant information associated with the keywords identified by the program such the speaker, time instance when it was said, the frequency of usage during the timeline captured by the repository, etc. When the data from multiple repositories are merged then the associated information also gets merged with accumulation of the scope in the merged repository.

The term “human tension” as used here refers to the complex interaction of the human mind with its surroundings that influences human response in any communication. The consolidation of all the factors influences personal communication. The language skills, empathy, prior history of communication between the two persons are some of the prominent factors that guide communication. It is well known in every culture that the state of mind at any instant dominates speech. That's why loud voices are often associated with anger. This invention is designed to extract such factors that are captured in communication and make connections among them to make a conclusion of the root cause of any conflict.

The term “conflicting trigger” as used here refers to the instance and the keyword during the communication between parties that gives rise to the conflict. The first instance of such a conflict causing keyword is also referred to as the “seed”. When the communication is analyzed in a sequential order then it allows to capture the psychological state by the language of the speaker.

The term “seed or route cause” used here refers to the first instance of the conflict causing keyword that is found to be triggering the conflict between the parties. This is determined by the sequentially analyzing the communication between the parties and then scoring all the keywords. The association of the keywords and the with context of linguistics provides a relative score. The first instance of such conflicting trigger is suggested as the seed or the root cause of the conflict to the analyzer. This suggestion is only to provide an unbiased perspective to the analyzer who then puts the results in real world scenario for further actions.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for detecting and analyzing electronic human tension based conflict and generating conflict assessment score, the method comprising:
receiving electronic communication data;
determining customer identification data associated with the electronic customer communication data by the contact center;
aggregating electronic communication data based on identification of a party from the electronic communication data;
analyzing the aggregated electronic communication data by applying a predetermined conflict assessment analysis to the electronic communication data;
generating a conflict assessment score based on said analysis, the conflict assessment score providing a party responsible for a human tension based conflict for the analyzed electronic communication data; and
displaying the conflict assessment score based on the generated conflict assessment data.

2. The method of claim 1, wherein conflict assessment analysis includes generating a local conflict assessment score by analyzing an individual electronic communication data from one party to another.

3. The method of claim 1, wherein conflict assessment analysis includes generating a global conflict assessment score by analyzing a set of the electronic communication data from a various individual electronic communication data from one party to another.

4. The method of claim 1, wherein the electronic communication data is at least one of electronic-mail data, web content data, text message data, voice over IP data, video content data and online forum data.

5. The method of claim 1, wherein the electronic communication data is social media data, update status, media feed, social media review, and social media data.

6. The method of claim 1, wherein the analyzing includes identifying the type of electronic communication data, and wherein the analyzing is based on the type of electronic communication data.

7. The method of claim 1, wherein analyzing includes determining identifying of a trigger or a conflict event in the electronic communication data.

8. The method of claim 1, wherein displaying of the conflict assessment score includes a score to identify a party responsible for the conflict in the electronic communication data.

9. A computer program product stored on a non-transitory computer readable medium including computer executable code for analyzing electronic communication data and generating conflict assessment score, the computer program product comprising: computer readable code to receive electronic customer communication data by a contact center; computer readable code to determine customer identification data associated with the electronic customer communication data by the contact center; computer readable code to aggregate electronic customer communication data by customer category from one or more sources based on identification of a customer from the electronic customer communication data; computer readable code to analyze the aggregated electronic communication data by applying a predetermined conflict assessment analysis to the electronic customer communication data; computer readable code to generate conflict assessment data based on said analyzing, the conflict assessment score providing a party responsible for a human tension based conflict for the analyzed electronic communication data; and computer readable code to display the conflict assessment score based on the generated conflict assessment data.

10. The computer program product of claim 9, wherein conflict assessment analysis includes generating a global conflict assessment score by analyzing a set of the electronic communication data from various individual electronic communication data from one party to another.

11. The computer program product of claim 9, wherein the electronic communication data is at least one of electronic-mail data, web content data, text message data, voice over IP data, video content data and online forum data.

12. The computer program product of claim 9, wherein the electronic communication data is social media data, update status, media teed, social media review, and social media data.

13. The computer program product of claim 9, wherein the analyzing includes identifying the type of electronic communication data, and wherein the analyzing is based on the type of electronic communication data.

14. The computer program product of claim 9, wherein analyzing includes determining identifying of a trigger or a conflict event in the electronic communication data.

15. The computer program product of claim 9, wherein displaying of the conflict assessment score includes a score to identify a party responsible for the conflict in the electronic communication data.
